(19) United States
(12) Patent Application Publication
(10) Pub. No.: US 2003/0061482 A1
(43) Pub. Date: Mar. 27, 2003

(54) Software security control system and method

(75) Inventor: John Frederick Emmerichs, Brown Deer, WI (US)

Correspondence Address: MICHAEL BEST & FRIEDRICH, LLP, 100 E WISCONSIN AVENUE, MILWAUKEE, WI, 53202, US

(73) Assignee: eFunds Corporation, Milwaukee, WI

(21) Appl. No.: 10/226,686

(22) Filed: Aug. 23, 2002

Related U.S. Application Data
(60) Provisional application No. 60/314,492, filed on Aug. 23, 2001.

(51) Int. Cl. H04L 9/00

(52) U.S. Cl. 713/165

(57) ABSTRACT

A method and apparatus for implementing a software security system in a customer computer system. The method includes requesting permission to display a security-controlled file or application feature when a user attempts to access the security-controlled file or application feature, determining a type of data in the security-controlled file or associated with the security-controlled application feature from at least two types of data, the at least two types of data changing dynamically, and determining whether the user has access to the type of data and providing access to the security-controlled file or application feature if the user has permission to access the type of data. The apparatus for the software security system includes a security repository module, an access security module, and a dynamic security module.

### RELATED APPLICATIONS

Priority is claimed under 35 U.S.C. §119 to U.S. Patent Application Serial No. 60/314,492 filed Aug. 23, 2001.

### BACKGROUND OF THE INVENTION

The invention relates to a method and apparatus for implementing software security controls in a customer computer system.

Customers, such as financial institutions or corporations, often need software with certain security controls. For example, a financial institution may want to allow only management-level employees to conduct certain transactions using the software. In order to prevent non-management employees from conducting those transactions, the software is configured to prohibit a non-management employee from being able to conduct the transaction. For example, when the management-level employee (i.e., manager) accesses the customer software with his user identification, the manager is allowed to click on an activated button in order to process a transaction. However, when the non-management employee accesses the software with his user identification, the non-management employee will not be allowed to click on the button, the button may not be activated, or the button may be completely hidden from the non-management employee's view.

The security controls that may be employed in the customer's software are limitless and depend on each individual customer's needs. When an employee accesses the customer's software via his workstation, each and every item, field, or button that appears on the monitor of the employee's workstation may be assigned a security key. Moreover, the conditions under which the software makes decisions may be assigned security keys. For example, a decision made by the software as to whether non-management employees may process certain financial transactions may be assigned a security key.

In the most common situations, when software is initially designed for a customer, software developers can implement the security controls easily. For example, the software developers configure the software so that all managers are allowed to conduct certain transactions, while non-management employees are not allowed to conduct those transactions. However, the customer's needs regarding security controls may change once the software is designed and installed into the customer's computer system. In that event, the customer's new security control needs must then be programmed into the existing software installed on the customer's computer system.

For example, the customer may decide to only allow senior managers to conduct certain transactions, because the customer may suspect a security breach in junior managers. In order to implement this security control change, the security administrator must make changes to the software installed in the customer's computer system or the software developers must re-design the software to implement the security control change. In either case, the old security controls remain in effect until the new security controls can be implemented. This may be undesirable for the customer. Continuing with the example, until the new security controls are implemented, the junior managers may continue to engage in unwanted conduct, because the customer cannot prevent them from doing so.

Although most security controls can be implemented rather easily when the software is being designed, software developers cannot predict every security control need the customer may have after the software is designed and installed. Even if the software developers study the customer's business before designing the security controls for the software, the customer's security control needs may change often and suddenly. Moreover, when the customer's security control needs do change, the customer generally cannot modify the software quickly and easily enough to effectively implement the changes.

### SUMMARY OF THE INVENTION

Accordingly, a need exists for a method and apparatus for implementing changes in security controls and programming new security controls into existing customer software without changing the customer software itself.

The invention provides a method of implementing a software security system into a customer computer system. The method includes requesting permission to display a security-controlled file or application feature when a user attempts to access the security-controlled file or application feature. The method also includes determining a type of data in the security-controlled file or associated with the security-controlled application feature from at least two types of data, the at least two types of data changing dynamically. The method further includes determining whether the user has access to the type of data and providing access to the security-controlled file or application feature if the user has permission to access the type of data. In some embodiments, the method includes downloading a security table to a client or web server computer's memory when the user logs on and removing the security table from the client or web server computer when the user logs off. In some embodiments, such tables are not stored in any permanent form on such computers, and are unavailable to the user. In one embodiment, the security-controlled file is a web page and the security-controlled application feature is a control in a web page.

The invention also provides a security software system stored on a server and a client computer. The software security system includes a security repository module stored on the server. The security repository module stores a configuration file. The software security system also includes an access security module stored on the client computer for requesting permission from the security repository module for a user to access on the client computer a security-controlled file or application feature. The software security system further includes a dynamic security module stored on the client computer for determining a type of data in the security-controlled file or associated with the security-controlled application feature from at least two types of data, the at least two types of data changing dynamically, and for determining whether the user has access to the type of data based on the configuration file. In some embodiments, the access security module downloads a security table from the security repository module when the user logs on to the client computer and removes the security table from the security repository module when the user logs off. In one embodiment, the security-controlled file is a web page, and the security-controlled application feature is a control in a web page.

Various other features and advantages of the invention are set forth in the following drawings, detailed description, and claims.

### BRIEF DESCRIPTION OF THE DRAWINGS

FIG. 1 illustrates a software security system embodying the invention.

FIGS. 2A, 2B, and 2C illustrate a flowchart embodying the method of the invention.

FIG. 3 illustrates an example of a graphical user interface for use with the system shown in FIG. 1.

FIG. 4 is a table of data types, values, and meanings for the graphical user interface shown in FIG. 3.

FIG. 5 is a table relating features of the graphical user interface of FIG. 3 to security permissions.

FIG. 6 is a table relating security permissions to appearances for the features of the graphical user interface of FIG. 3 when access is denied to a user.

FIG. 7 is a table of security permissions for a manager user.

FIG. 8 is a table of security permissions for a normal user.

FIG. 9 is a table of security permissions for an untrusted user.

FIG. 10 is a table of security permissions for a manager user.

FIG. 11 is a table of relationships, user profiles, data elements, and data element values.

FIG. 12 illustrates another software security system embodying the invention.

FIG. 13 illustrates still another a software security system embodying the invention.

### DETAILED DESCRIPTION OF THE INVENTION

Before one embodiment of the invention is explained in full detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including” and “comprising” and variations thereof is meant to encompass the items listed thereafter and equivalents thereof as well as additional items.

The term “customer” as used hereinafter refers to any type of corporation, business entity, financial institution or other entity or group that requires software having security controls. The term “user” as used hereinafter refers to anyone who uses the customer's software, such as an employee of the customer.

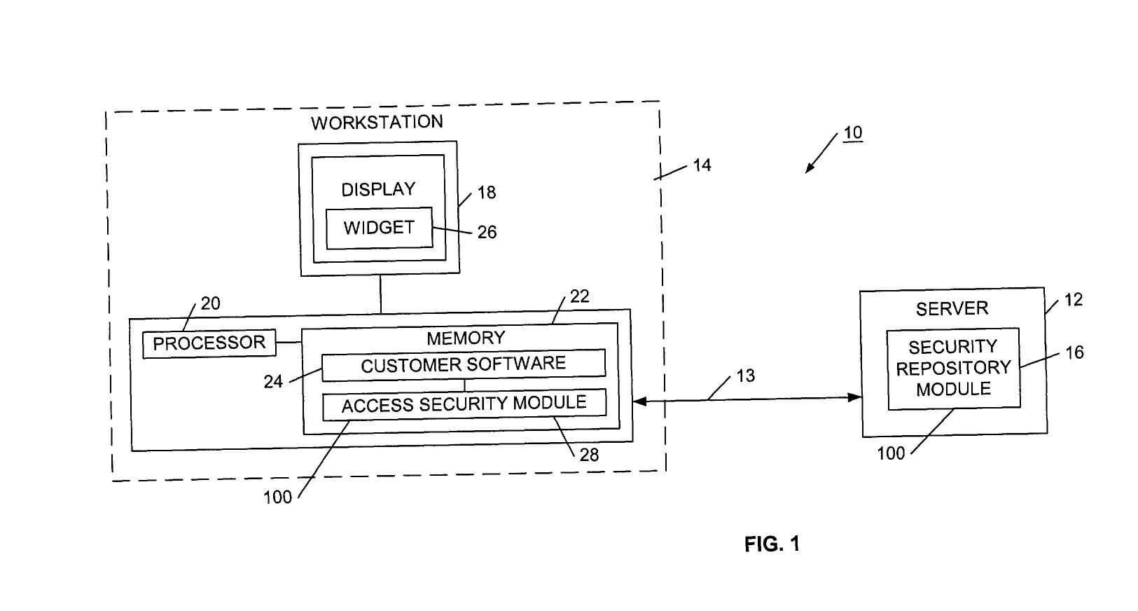

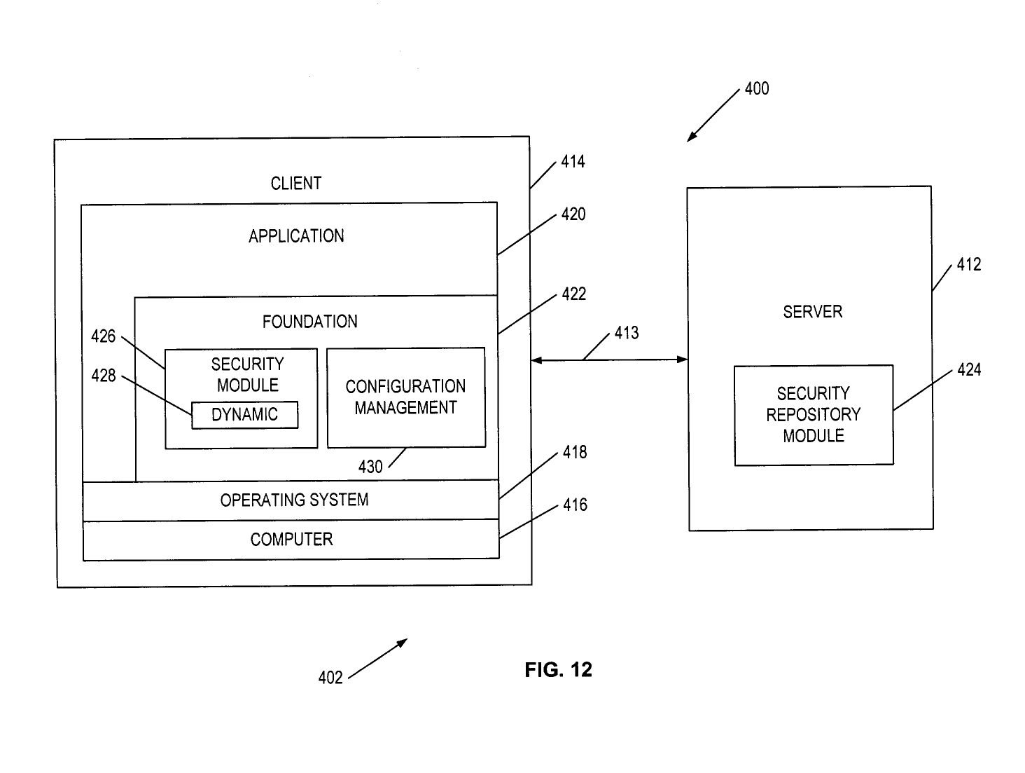

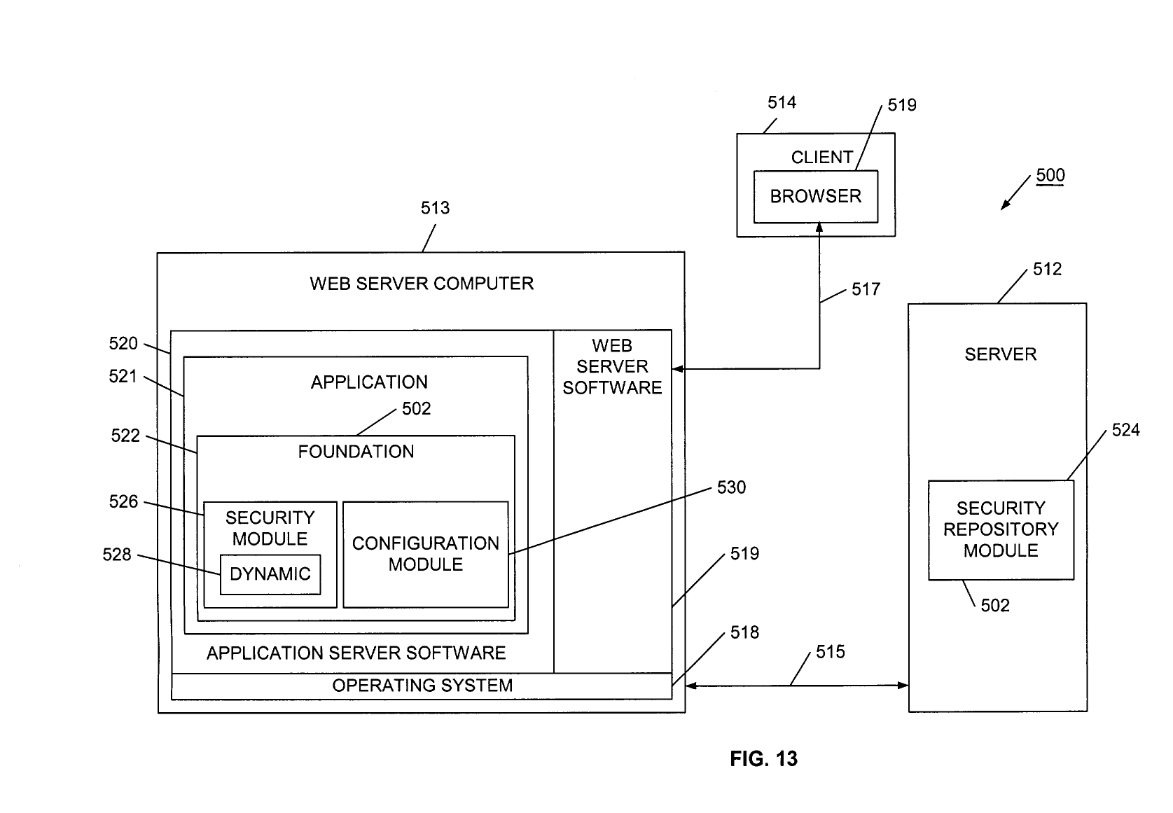

FIG. 1 illustrates a customer computer system 10 for use in implementing a software security system 100 embodying the invention. The customer computer system 10 includes a server 12 and one or more workstations 14 coupled to the server 12 via one or more network connections 13. In general, the server 12 can be any computer connected to or in communication with the customer computer system 10. In some embodiments, the server 12 is a mainframe computer located inside the data center of the customer's facility. The workstations 14 include a display 18, a processor 20, and memory 22. Customer software 24 is installed within the memory 22 of the workstations 14. The software security system 100 is implemented in the customer computer system 10 by installing a security repository module 16 in the server 12 and an access security module 28 in the memory 22 of the workstations 14. The access security module 28 can include a dynamic security module (as shown in FIGS. 12 and 13).

The software security system 100 utilizes several components which may be defined by the customer or by the software developer. The software security system 100 first utilizes the individual functions or features within the customer software 24 to which the customer wants to assign security controls. These features are referred to hereinafter as “widgets” (designated in FIG. 1 with the numeral 26). For example, the widgets 26 can be a graphical user interface (GUI), one or more controls on a GUI, a processing feature accessed through such a control, an abstract process defined by the software developer (e.g., a calculation, a determination, a formula, a step, an act, etc.), a security-controlled file, a security-controlled web page, or any other suitable function or feature to which the customer wants to assign security controls. As shown in FIG. 1, a widget 26 can be a particular button-style GUI that appears on the display 18 of the user's workstation 14 when the user accesses the customer software 24. However, the widgets 26 can be any function or feature of the customer software and are not limited to the particular examples described herein. Each widget has a corresponding security key defined by the software developer, which is built into the customer software 24.

The software security system 100 also utilizes “security permissions,” which grant access to each of the individual widgets 26. The security permissions may be defined by the software developer, such as for the software's default settings, or by the customer to define the widgets 26 to which the users may have access.

The software security system 100 further utilizes “denied appearances,” which define how the software will display the widgets 26 for a given security permission when access is denied to a particular user. For example, if the widget 26 is a button-style GUI and the user should not have access thereto, the denied appearances for the widget 26 will dictate that the button is hidden from the user's view or that the button is not activated for the user. In some embodiments, a non-activated, button-style GUI is displayed in a different color, with a line or other marks through the text, or with the text color almost matching the button's background color. In general, the denied appearances for the widgets 26 can be any suitable indication that access is denied. In some embodiments, when a user attempts to access a widget 26, a pop-up message indicates that access is denied. In some embodiments, the denied appearances for the widgets are defined by the software developer. However, in other embodiments, the customer can change the default denied appearances or the customer can define its own denied appearances.

The software security system 100 further utilizes “user profiles,” which define the security permissions of each user. The user profiles grant security permissions to individual users. The user profiles can be defined by the software developer for general groups of users, such as managers or normal users, or the user profiles can be defined by the customer to match their own organizational requirements. Accordingly, the customer can use the standard profiles for groups of users defined by the software developer, or the customer can develop its own user profile groups or user profiles for each individual user. In general, the software developer and/or the customer can define the user profiles according to any suitable criteria for one particular widget 26, a group of widgets 26, or the customer software 24.

The software security system 100 further utilizes “relationships,” which define how a security permission can be related to a user profile. The relationships can differ depending on how the users working with a user profile are to use the widgets 26 granted to them through the security permissions. The software developer and/or the customer can define the relationships in order to create any suitable connection or association between two or more of the widgets 26, the denied appearances, the security permissions, and the user profiles. In some embodiments, the software developer and/or the customer defines a relationship between each user profile and each security permission.

The software security system 100 further utilizes “data elements,” which represent security controls for each of the relationships, and corresponding “data element values,” which represent the possible values for the security controls. In general, the customer is allowed to determine and alter the data element values corresponding to each data element in order to implement particular security controls. In one example, the customer can set the data element values so that users with a manager user profile can access the widgets 26 associated with the relationship “Transaction Processing” (which ties the manager user profile to a transaction processing related security permission) when the data element named “Network ID” has a data element value of “CRS” (for the CIRRUS network). In another example, the customer may want to allow some users to access VISA transactions and other users to access MasterCard transactions. A first relationship/user profile combination is configured to allow access to VISA transactions, and a second relationship/user profile combination is configured to allow access to MasterCard transactions. The data element corresponding to the first combination is named “Network ID” and has a data element value of “VNT,” and the data element corresponding to the second combination is also named “Network ID” but has a data element value of “MCC.”In some embodiments, each data element represents a type of data that can be present in the widgets 26 or in one particular widget 26, and each corresponding data element value indicates whether that particular type of data is present within the widget 26 the user is attempting to access.

The components utilized by the software security system 100, including the security permissions, the denied appearances, the user profiles, the relationships, the data elements, and the data element values, are collectively referred to as the “security configuration files” and can be stored on the server 12 within the security repository module 16. However, the security configuration files can be stored in any suitable location, as long as the files cannot be accessed by users at workstations 14. The security repository module 16 stores, manages, and delivers the security configuration files to the access security module 28 within each of the workstations 14. The security repository module 16 delivers the security configuration files to each user's workstation 14 when the user logs on to the workstation 14 with their user identification. Thus, regardless of the workstation used, the user will always work with the appropriate security controls as defined by the security configuration files downloaded from the security repository module 16. The security configuration files are downloaded from the security repository module 16 to the access security module 28 within the memory of the workstation 14 each time the user logs on to the workstation 14, and the security configuration files are removed and erased from the access security module 28 each time the user logs off of the workstation 14. In this manner, individual users are prevented from overriding the security controls, either by altering the settings of their own workstation 14 or by using another workstation 14 or by having direct access to the security tables on any workstation 14.

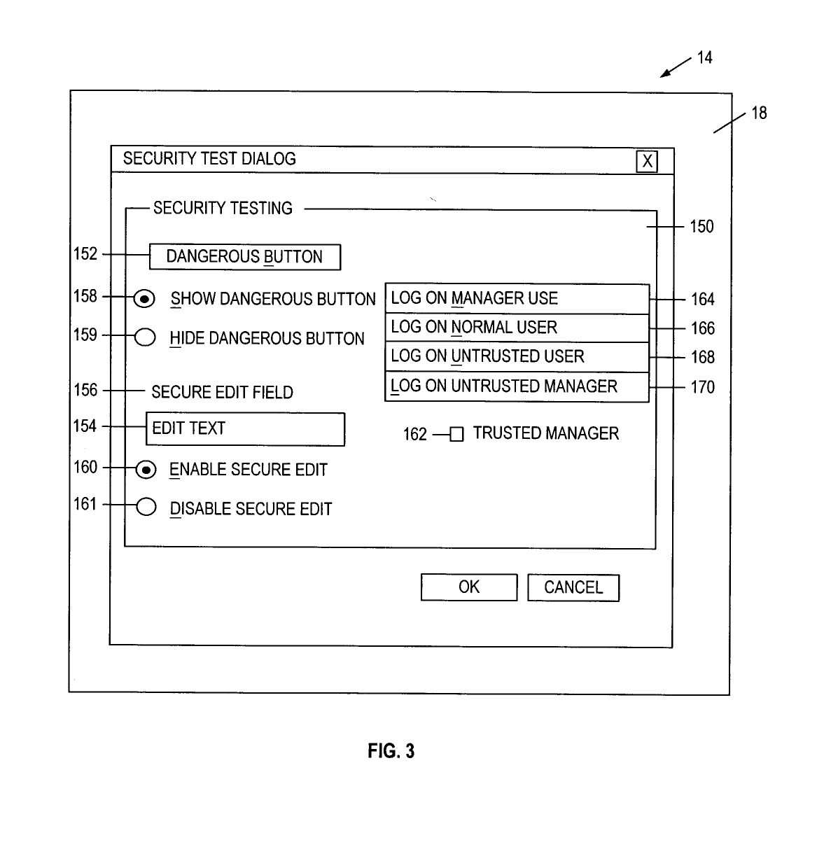

The method of the invention will be described with respect to an example, as illustrated by the Security Test Dialog GUI 150 shown in FIG. 3. This example, and all the examples described herein, are for purposes of illustration and explanation only and do not limit the scope of the appended claims. For the example shown in FIG. 3, the display 18 on the user's workstation 14 can include a button associated with a highly-secured function, i.e., a Dangerous Button 152, and a text-entry field to which certain users may not have access, i.e., a Secure Edit Field 154. The Dangerous Button 152 is hidden when access is denied to the user, and the Secure Edit Field 154 (and its label 156) is inactivated when access is denied to the user. A first set of radio buttons 158 and 159 are used to control whether the Dangerous Button 152 is hidden, and a second set of radio buttons 160 and 161 are used to control whether the Secure Edit Field 154 is inactivated. The radio buttons 158, 159, 160 and 161 are themselves hidden when the user has no need for them, such as when access to the Dangerous Button 152 and the Secure Edit Field 154 is always or never available. A check box 162 controls whether managers are “trusted” or not. Four buttons 164, 166, 168, and 170 simulate the log on of four types of users, namely manager users, normal users, untrusted users, and untrusted manager users, respectively.

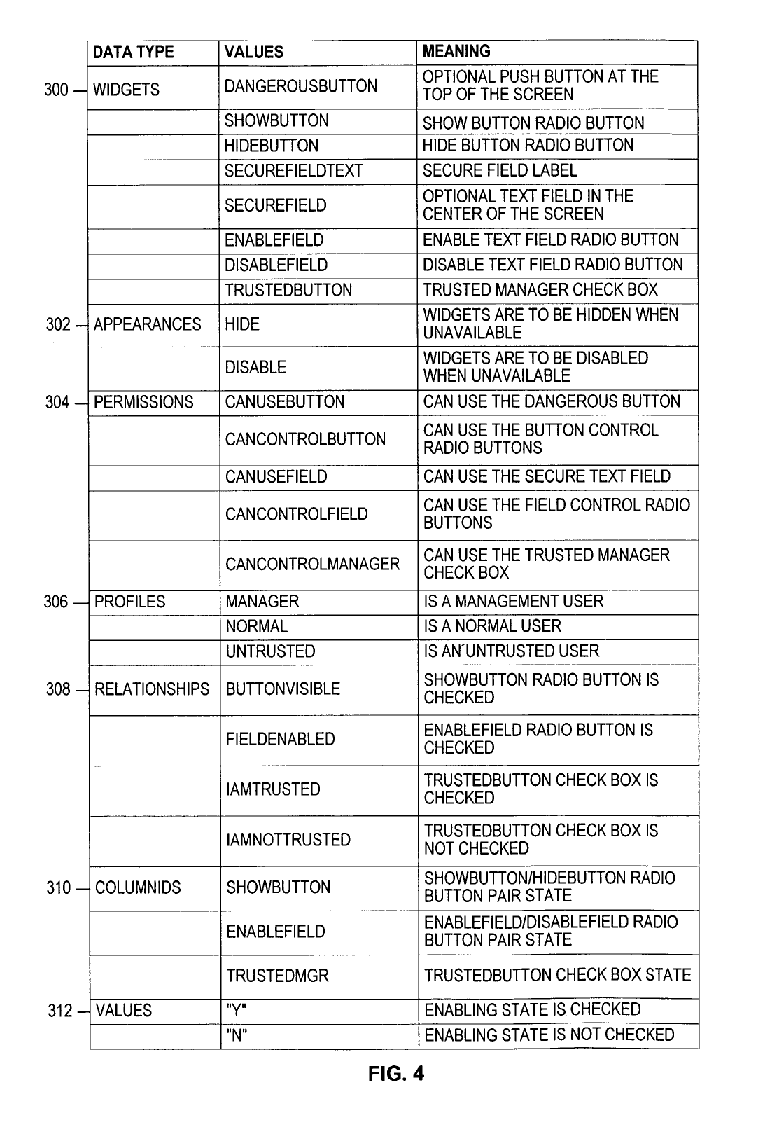

FIG. 4 is a table including the components and their corresponding values and meanings used by the software security system 100. The components (in the column labeled “Data Type”) include widget descriptions 300, denied appearances 302, security permissions 304, user profiles 306, relationships 308, data elements 310, and data element values 312. FIG. 4 also includes the component values (in the column labeled “Values”) and the component meanings (in the column labeled “Meaning”) for each of the components of the security configuration files.

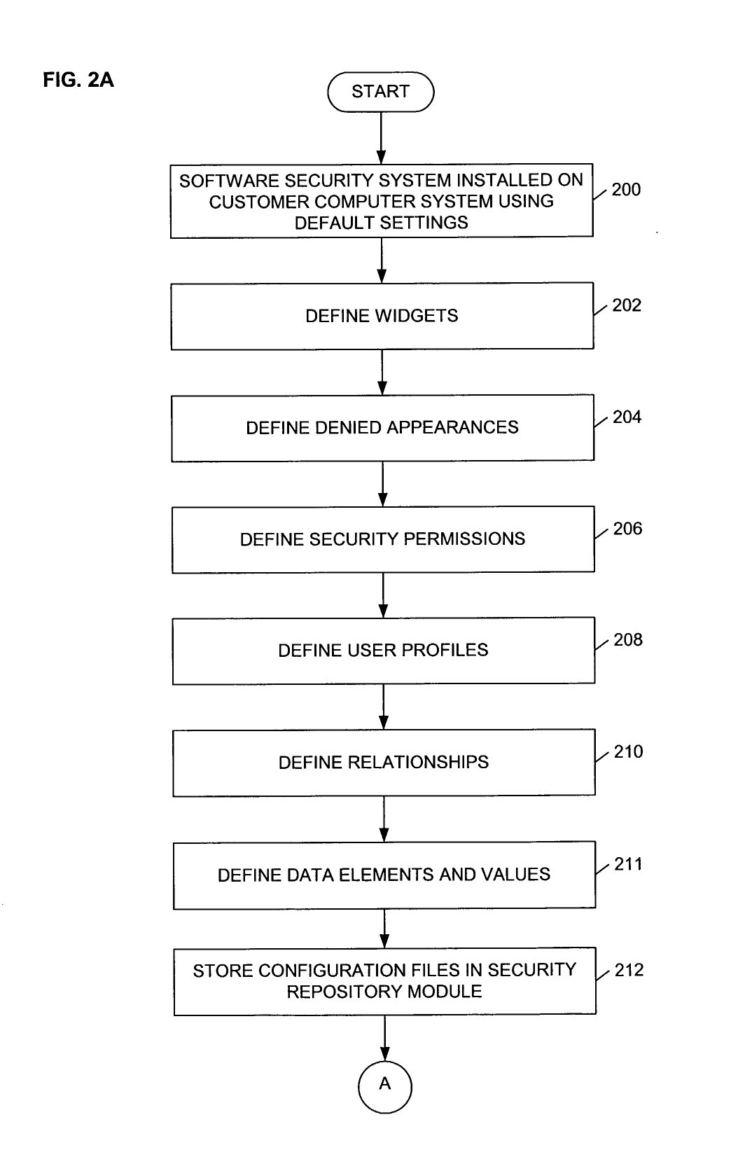

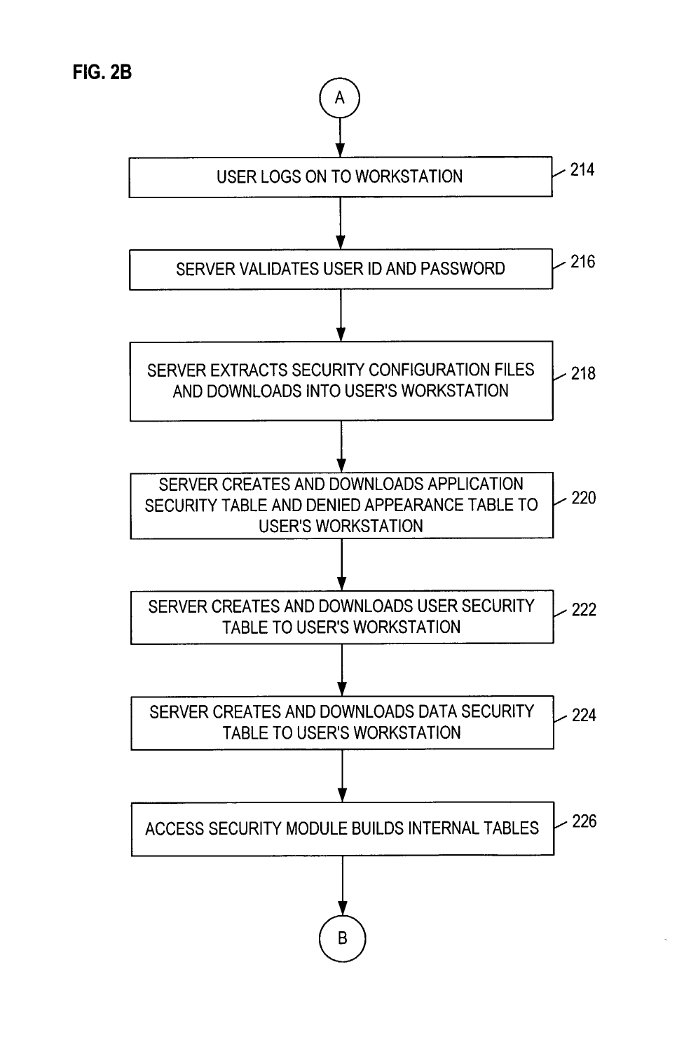

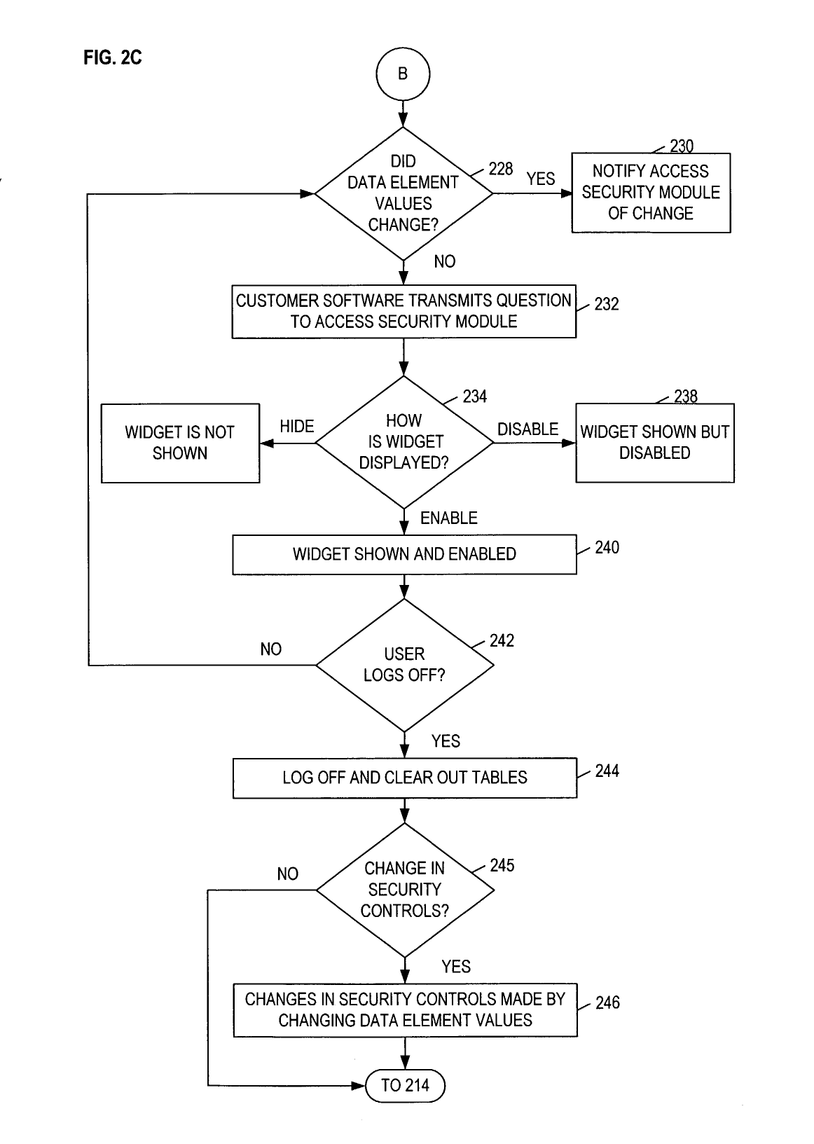

According to the method of the invention, as illustrated in FIGS. 2A, 2B and 2C, the software security system 100 is installed (at 200) into the customer computer system 10 using default security settings. The customer (or a security administrator employed by the customer) defines (at 202) which widgets 26 to which security controls should be assigned. The widget descriptions 300 shown in the example illustrated in FIG. 4 are as follows: an optional push button at the top of the screen associated with a highly-secured function, i.e., the Dangerous Button 152 (widget value “DangerousButton”); a radio button 158 that can be selected to show the Dangerous Button 152 (widget value “ShowButton”); a radio button 159 that can be selected to hide the Dangerous Button 152 (widget value “HideButton”); an optional label 156 for the Secure Edit Field 154 (widget value “SecureFieldText”); an optional text-entry field in the center of the screen, i.e., the Secure Edit Field 154 (widget value “SecureField”); a radio button 160 that can be selected to enable the Secure Edit Field 154 (widget value “EnableField”); a radio button 161 that can be selected to disable the Secure Edit Field 154 (widget value “DisableField”); and a check box 162 that can be checked if a manager user is considered “trusted” (widget value “TrustedButton”).

The customer also defines (at 204) the denied appearances 302 corresponding to each of the widget descriptions 300 when the user is not given access to one of the widgets 26. The denied appearances 302 for the example are as follows: the widgets are to be hidden when unavailable (denied appearance value “Hide”) or the widgets are to be disabled when unavailable (denied appearance value “Disable”).

The customer further defines (at 206) the security permissions 304 used to control access to the widgets 26 (according to their corresponding widget descriptions 300). The security permissions 304 for the example are as follows: the user can use the Dangerous Button 152 (security permission value “CanUseButton”), the user can use the radio buttons 158 and 159 that control the Dangerous Button 152 (security permission value “CanControlButton”), the user can use the Secure Edit Field 154 (security permission value “CanUseField”), the user can use the radio buttons 160 and 161 that control the Secure Edit Field 154 (security permission value “CanControlField”), and the user can use the check box 162 for designating a manager as “trusted” (security permission value “CanControlManager”).

The customer further defines (at 208) the user profiles 306 that will be assigned to each individual user. The user profiles 306 for the example are as follows: the user is a management user (user profile value “Manager”), the user is a normal user (user profile value “Normal”), and the user is an untrusted user (user profile value “Untrusted”).

The customer further defines (at 210) the relationships 308 for the various states of the widgets 26 (according to their corresponding widget descriptions 300). The relationships 308 for the example are as follows: the Dangerous Button 152 is visible on the screen (relationship value “ButtonVisible”), the Secure Edit Field 154 is visible on the screen (relationship value “FieldEnabled”), the check box 162 to designate a “trusted” manager is checked (relationship value “IAmTrusted”), and the check box 162 to designate a “trusted” manager is not checked (relationship value “IAmNotTrusted”).

The customer further defines (at 211) the data elements 310 (sometimes called “Column Ids” when the data elements are data columns in a database table) are used to link the relationships and the security permissions identified by a relationship/user profile pair. The data elements 310 for the example are as follows: the current state of radio buttons 158 and 159 for controlling the Dangerous Button 152 (Column ID value “ShowButton”), the current state of radio buttons 160 and 161 for controlling the Secure Edit Field 154 (Column ID value “EnableField”), and the current state of the Trusted Manager checkbox 162 (Column ID value “TrustedMgr”). The customer also defines (at 211) the data element values 312 that each of the data elements 310 may have. The data element values 312 are as follows: the enabling state is checked (data element value “Y”) and the enabling state is not checked (data element value “N”).

The customer (or the security administrator employed by the customer) can define the widgets 26, the widget descriptions 300, the denied appearances 302, the security permissions 304, the user profiles 306, the relationships 308, and the data elements 310 in any suitable order. The corresponding method steps 202 through 212 as described above can occur in any suitable order, and the customer is not required to perform the steps in the particular order shown in FIG. 2A.

Once the components are defined by the customer, the components and their values (i.e., the table shown in FIG. 4) are stored (at 212) in the security repository module 16 and are designated collectively as the security configuration files. Referring to FIG. 2B, a user may then log on (at 214) to a workstation 14 within the customer computer system 10. The user logs on to the workstation 14 with a valid user identification and password. The server 12 validates (at 216) the user identification and password. The server 12 then extracts (at 218) the security configuration files for the particular user from the security repository module 16 and downloads the security configuration files into the access security module 28 on the user's workstation 14.

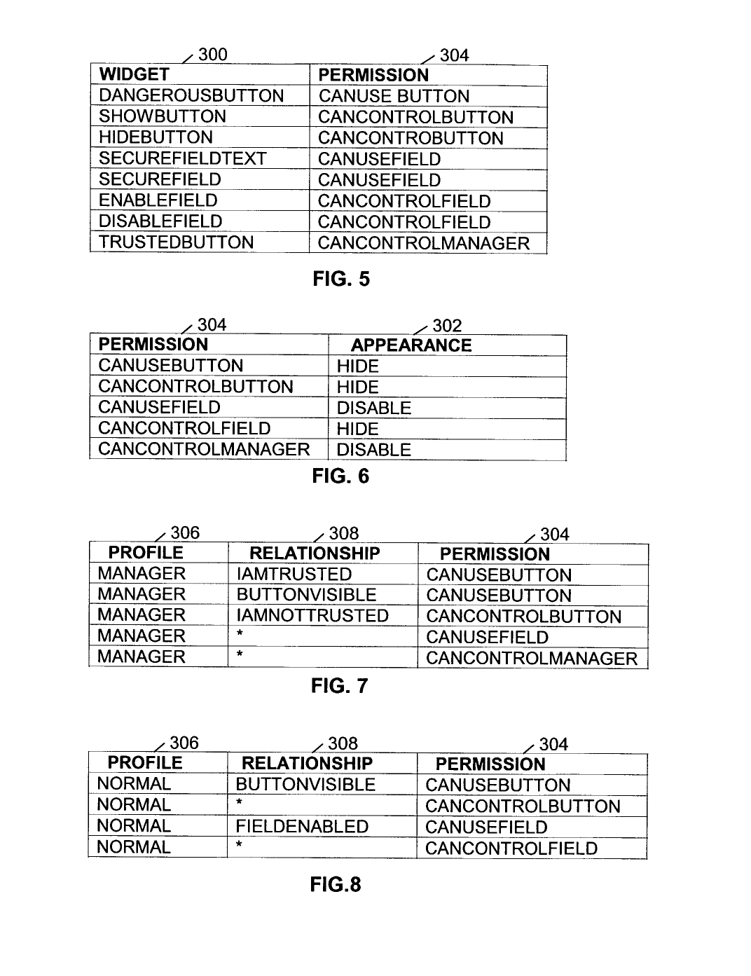

The server 12 creates and downloads (at 220) to the user's workstation 14 an Application Security Table (as shown in FIG. 5) which relates the widgets 26 (according to their corresponding widget descriptions 300) to the security permissions 304. The log on buttons 164, 166, 168, and 170 default to a condition or state of always being available to every user, so they do not need to be in the Application Security Table. The server 12 also creates and downloads (at 220) to the user's workstation 14 a Denied Appearance Table (as shown in FIG. 6) which relates the denied appearances 302 to each of the security permissions 304, in order to describe how to display the widgets 26 when the user is denied access to the widget 26. With the exception of the Secure Edit Field 154, its label 156 and the Trusted Manager check box 162, the widgets 26 that the user does not have access to can be hidden from the user's view on display 18. The values in the Application Security Table and the Denied Appearance Table do not change from user to user. The Application Security Table and the Denied Appearance Table are stored within the access security module 28.

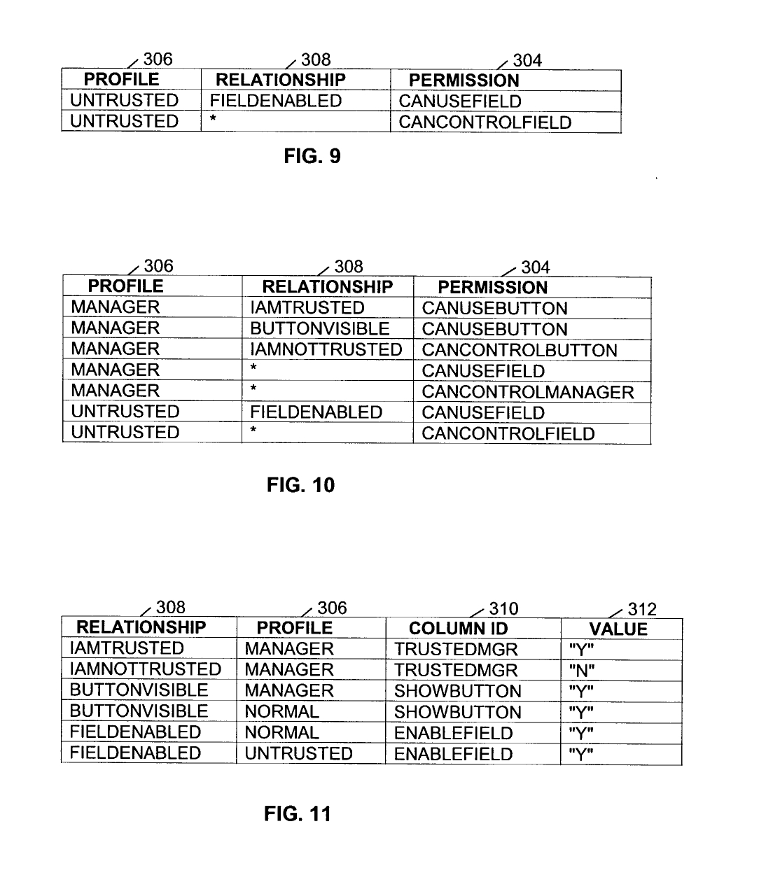

Depending on the user profile of the user, the server 12 creates and downloads (at 222) to the user's workstation 14 a User Security Table (e.g., one of the four tables as shown in FIGS. 7-10 for the example). Each User Security Table relates the user profile 306 to the relationships 308 and the security permissions 304 available to the user. FIG. 7 illustrates the User Security Table for the manager user profile. If the manager is trusted, the manager has access to the Dangerous Button 152, and does not see the radio buttons 158 and 159 that control the Dangerous Button 152. Alternatively, the manager has access to the radio buttons 158 and 159, and the manager only has access to the Dangerous Button 152 when radio button 158 is selected. The manager always has access to the Secure Edit Field 154, and does not see the radio buttons 160 and 161 that control the Secure Edit Field 154. The managers are also the only users who can control the Trusted Manager check box 162. FIG. 8 illustrates the User Security Table for the normal user profile. The normal users have access to the Dangerous Button 152 and the Secure Edit Field 154 through the radio buttons 158, 159, 160, and 161. FIG. 9 illustrates the User Security Table for the untrusted user profile. The untrusted users never have access to the Dangerous Button 152 or its radio buttons 158 and 159. The untrusted users can control the Secure Edit Field 154 through the radio buttons 160 and 161, just as the normal users can control the Secure Edit Field 154. FIG. 10 illustrates the User Security Table for the untrusted manager user profile. The untrusted manager user profile is a combination of the manager user and the untrusted user profiles. The Secure Edit Field 154 is available to the untrusted manager user at all times, because the manager user profile provides constant access. The radio buttons 160 and 161 for the Secure Edit Field 154 are available for the untrusted manager user, but they do not inactivate the Secure Edit Field 154. The User Security Table will usually change from user to user and is stored in the access security module 28 of each user's workstation 14.

The server 12 creates and downloads (at 224) the Data Security Table, as illustrated in FIG. 11, to the user's workstation 14. The Data Security Table relates the relationships 308, the user profiles 306, the data elements 310, and the data element values 312. For example, the last entry in the Data Security Table shown in FIG. 11 indicates that the ability to enable the Secure Edit Field 154 (relationship value “FieldEnabled”) for an untrusted user (user profile value “Untrusted”) will only be available when the data element that allows the user to enable the Secure Edit Field 154 (Column ID value “EnableField”), which is controlled by the radio button 160, has a data element value indicating that the enabling state is checked (data element value “Y”). The Data Security Table can, but generally does not, change from user to user, and is stored in the access security module 28 of the user's workstation 14.

When all of the tables shown in FIGS. 5-11 have been created and downloaded into the access security module 28 of the user's workstation 14, the access security module 28 builds (at 226) three more tables internally. The first table is a list of the widget descriptions 300 for the widgets 26, whose access may change, for each data element 310 that may change. The second table is a list of current data element values 312 for each data element 310 that may change. The third table is a list of the current availability values for each widget description 300 of which the access security module 28 is aware. The current availability values include the following: (a) enabled—the user can see and use the widget; (b) disabled—the user can see the widget but cannot use the widget; and (c) hidden—the user cannot see or use the widget.

Once the access security module 28 builds (at 226) the three internal tables, the customer software 24 displays the graphical user interface of FIG. 3 (i.e., the Security Test Dialog box) on the display 18 of the user's workstation 14 and allows the user to attempt to access the widgets 26 that appear on display 18.

While the customer software 24 is operating, the data element values 312 may change. Referring to FIG. 2C, the software security system 100 determines (at 228) whether one or more of the data element values 312 stored in the security repository module 16 has changed. In the example, the data element values 312 change if the user selects one of the radio buttons 158, 159, 160, or 161, or if the user changes the Trusted Manager checkbox 162. If a data element value 312 has changed, the customer software 24 notifies (at 230) the access security module 28 of the change. The access security module 28 then updates its internal tables, including the list of the current availability values for each widget description 300 of which the access security module 28 is aware.

In some embodiments, if no data element values 312 have changed, the customer software 24 continues to operate, allowing the user to attempt to access the widgets 26 that appear on the display 18. In the example, the user may attempt to click on the Dangerous Button 152 or attempt to enter text into the Secure Edit Field 154. When the user attempts to access one particular widget 26, the business logic of the customer software 24 formulates and transmits (at 232) a message to the dynamic security module in the access security module 28 with a question as to whether the particular widget 26 is available for the user and with the default display value for the particular widget 26. The dynamic access security module then consults the table of the current availability values for the widget descriptions 300 to determine if the particular widget 26 is available.

If access to the particular widget 26 is denied and the widget 26 should be disabled, the customer software 24 will show the widget 26 on the display 18, but the widget 26 will be disabled so that the user cannot use the widget 26 (at 238). If access to the widget 26 is denied and the widget 26 should be hidden, the customer software 24 will not display the widget 26 (at 236). If access to the widget 26 is allowed and the widget 26 should be enabled, the customer software 24 displays and activates the widget 26 (at 240). If the widget 26 is not in the table of current availability values, the security module 28 will return the default display value.

In some embodiments, when the customer software 24 initially displays the widgets 26 to the user (e.g., when the customer software 24 creates a GUI including a form or a web page), the customer software 24 checks the status of each widget 26 in order to enable, disable or hide each widget 26 as appropriate. In some embodiments, the customer software 24 only re-checks the status of each dynamically-changing widget 26 to enable, disable or hide each dynamically-changing widget 26 as appropriate when the data element value for a dynamically-changing widget 26 changes. For example, when a user logs on to a workstation 14, the customer software 24 checks whether the user has access to each widget 26 and builds an initial GUI. Once the initial GUI is built, the customer software 24 only checks whether the user has access to a widget 26 if a data element value for the widget 26 has changed since the customer software 24 built the initial GUI. Once access to the widget 26 is initially established, the customer software 24 will not necessarily check whether the user has access to the widget 26 each time the user attempts to access the widget 26 during the user's current session.

In some embodiments, the customer software 24 displays the widgets 26 without first determining whether the user has access to each widget 26, and the customer software 24 only determines whether the user has access to the widget 26 when the user attempts to access the widget 26. In other words, the customer software 24 allows a user to attempt to access a widget 26 before determining whether the widget 26 is available to the user. Once the user attempts to access the widget 26, the customer software 24 then checks the widget's availability and notifies the user with an error message if access to the widget 26 is denied. In this embodiment, the data element value of a dynamically-changing widget 26 can change rapidly (as when a user scrolls through a list or grid) without the appearance of a “flashing” widget as the availability of the widget 26 changes.

In general, the user can continue to attempt to access the widgets 26, until the user has finished the current session. Once the user has finished the current session, the user can log off of the workstation 14. The software security system 100 determines (at 242) whether the user has logged off of the workstation 14. If the user has not logged off of the workstation 14, the customer software 24 again determines (at 228) whether one or more data element values 312 have been changed. If the user has logged off, the security configuration files and the generated tables are removed and erased from memory within the access security module 28.

The security administrator for the customer may decide (at 245) to change the security controls for the customer software 24 at any time during the operation of the customer software 24 by changing (at 246) any of the data element values 312 in the security configuration files stored within the security repository module 16. However, the new security controls are generally not implemented for the specific user until the user logs off of the workstation 14 and then logs back on (at 214) to any workstation 14 within the customer computer system 10. Once the user logs back on (at 214) to any workstation 14 within the customer computer system 10, the server 12 transmits the new data element values 312 from the security repository module 16 to the access security module 28. The access security module 28 recalculates the tables describing the current availability of each widget 26. Once the access security module 28 recalculates the tables describing the availability of each widget 26 and the customer software 24 transmits the question as to whether the widget 26 is available to the user, the updated tables in the access security module 28 will reflect the most recent changes in the security controls. Thus, all the access security module 28 decisions are based on the tables downloaded when the user logs on (at 214) to the workstation 14, and by the data element values 312 stored within the security repository module 16.

Default security permissions are included in the customer software 24. The default security permissions are associated with each widget description 300 in the customer software 24, so that it is unnecessary for the customer to assign security controls to every widget 26 of the customer software 24. The customer only identifies the widgets 26 that require different security controls for different users.

FIG. 12 illustrates another customer computer system 400 for use in implementing a software security system 402 embodying the invention. The customer computer system includes a server 412 and one or more workstations or client computers 414 coupled to the server 412 via one or more network connections 413. In general, the server 412 can be any computer connected to or in communication with the customer computer system 400. In some embodiments, the server 412 is a mainframe computer located inside the data center of the customer's facility. The workstations 414 include a computer or processor 416, an operating system 418, an application 420, a foundation 422, a display (not shown) and memory (not shown). The application 420 is stored in memory and runs on the operating system 418. The application 420 can be any type of Microsoft Windows® application or any other type of personal computer application. In some embodiments, the application 420 is an application for accessing and processing records relating to electronic-fund-transfer (EFT) transactions.

The software security system 402 is implemented in the customer computer system 400 by installing a security repository module 424 in the server 412 and the foundation 422 in the application 420. In some embodiments, the foundation 422 is directly embedded in the application 420. The foundation 422 can be a dynamic link library that can be embedded in the application 420 in order to communicate with the application 420 and perform various functions in conjunction with the application 420. Also, the foundation 422 can also be written in an object-oriented programming language, such as Delphi, Object Pascal or C++, in order to be compatible with most Microsoft Windows® and personal computer applications. In some embodiments, the foundation 422 includes an access security module 426, a dynamic security module 428, and a configuration management module 430. The software security system 402, including the foundation 420 and the access security module 426, is configured and operates in a similar manner to the software security system 100 described above in order to assign security controls to various widgets.

The following code is an example of Object Pascal code that can be embedding in the application 420 for implementing the security control features of the software security system 402:

strNetIDEMS :=trim(ProcessedByNetIDEdit.Text);

FoundDLLObject.PasNotifyNewValue (‘NET_ED_EMS’,strNetIDEMS);

if (FoundDLLObject.PasGetStatusFromFullControlTable

(ProcessBtn.DlxFoundObject.SecurityKey, HIDE_CONTROL)

[symbol] ENABLE_CONTROL) then begin

ProcessBtn.Enabled :=False;

end

else

ProcessBtn.Enabled :=True;

The purpose of this Object Pascal code is for the application 420 to notify the dynamic security module 428 within the access security module 426 of a new data element value for a particular data element. When a user attempts to access a widget 26, the application 420 notifies the dynamic security module 428 that a new data element value of “strNetIDEMS” is present for the data element “NET_ID_EMS.” The dynamic security module 428 tracks the data element values in order to determine if a change is made to a data element value to indicate a change in the type of data associated with the widget 26. The application 420 communicates with the dynamic security module 428 to determine whether the user has permission to access the widget 26 including the data element value of “strNetIDEMS.” The application 420 provides to the access security module 426 the denied appearance values of “HIDE_CONTROL” and “ENABLE_CONTROL.” The application 420 also provides to the access security module 426 the security key that has been assigned to the widget 26. In response to the request made by the application 420, the dynamic security module 428 within the access security module 426 determines and informs the application 420 as to whether the security key is enabled or disabled. The Object Pascal code can be embedded in the application 420 in order to communicate with the access security module 426 whenever a security-controlled widget 26 includes a new type of data represented by a new data element value.

FIG. 13 illustrates still another customer computer system 500 for use in implementing a software security system 502 embodying the invention. The customer computer system 500 includes a server 512 coupled to a web server computer 513 via one or more network connections 515. The customer computer system 500 also includes one or more workstations or client computers 514 coupled to the web server computer 513 via one or more network connections 517. Each client computer 514 includes a web browser 519. The server 512 can be any computer connected to or in communication with the customer computer system 500. In some embodiments, the server 512 is a mainframe computer located inside the data center of the customer's facility. The web server computer 513 can also be any computer connected to or in communication with the customer computer system 500, or the web server computer 513 can be a mainframe computer located at a web site hosting facility, a customer's facility, or any other suitable location. The web server computer 513 includes an operating system 518, web server software 519, application server software 520 that cooperates with the web server software 519, a web application 521, a foundation 522 and memory (not shown). The web application 521 is stored in memory and runs within the application server software 520. The web application 521 can be any type of web-based application compatible with standard commercial web server software (for example, but not limited to, Apache, Netscape Enterprise Server or IIS) and standard commercial application server software (for example, but not limited to, JRun, WebSphere or WebLogic). In some embodiments, the web application 521 is a web-based application for accessing records relating to electronic-fund-transfer (EFT) transactions.

The software security system 502 is implemented in the customer computer system 500 by installing a security repository module 524 in the server 512 and the foundation 522 in the web application 521 on the web server computer 513. In some embodiments, the foundation 522 is directly embedded in the web application 521. The foundation 522 can be a dynamic link library that can be embedded in the web application 521 in order to communicate with the web application 521 and perform various functions in conjunction with the web application 521. Also, the foundation 522 can be written in a machine-independent, object-oriented programming language, such as Java, in order to be compatible with commercial application server software. In some embodiments, the foundation 522 includes an access security module 526, a dynamic security module 528, and a configuration management module 530. The software security system 502, including the foundation 522 and the access security module 526, is configured and operates in a similar manner to the software security systems 100 and 400 described above in order to assign security controls to various widgets.

The following code is an example of Java code that can be embedded in the web application 521 for implementing the security control feature of the software security system 502:

<% security.notifyNewValue(“NET_ID_EMS”, strNetIdEms);

if (security.checkSecurity (HIDE_{—CONTROL, “OPTN}_EMS”,
“EMS_CASE_UPD”) ==ENABLE_CONTROL)
{

%>

<input type=“button” value= “Process” name=“ProcessBtn”
onClick=“processOKClick( )”>

<%

}

%>

The purpose of this Java code is for the web application 521 to notify the dynamic security module 528 within the access security module 526 of a new data element value for a particular data element. When a user attempts to access a widget 26, the web application 521 notifies the dynamic security module 528 that a new data element value of “strNetIdEms” is present for the data element “NET_ID_EMS.” The dynamic security module 528 tracks the data element values in order to determine if a change is made to a data element value to indicate a change in the type of data associated with the widget 26. The web application 521 will then communicate with the access security module 526 to determine whether the user has permission to access the widget including the data element value of “strNetIdEms.” The web application 521 provides to the access security module 526 the default denied appearance value of “HIDE_CONTROL” and the security permission of “OPTN_EMS.” The web application 521 also provides to the access security module 526 the security key of “EMS_CASE_UPD” that has been assigned to the widget 26. In response to the request made by the web application 521, the access security module 526 returns a value of “ENABLE=CONTROL” to inform the web application 521 that the user does have access to the security-controlled file. The access security module 526 then provides the following code to create the widget 26 on the user's web browser representing the security-controlled file or feature:

<input type=“button” value=“Process” name=“ProcessBtn”

onClick=“processOKClick( )”>

The Java code can be embedded in the web application 521 in order to communicate with the dynamic security module 528 within the access security module 526 whenever a web page includes a new type of data represented by a new data element value.

The software security systems 100, 400 and 500 allow a customer to modify the security controls within their existing software without having to re-design the software themselves or have a software developer re-design the software. The security controls can be changed as often and as quickly as necessary by the customer's security administrator. The customer's security administrator merely makes changes to configuration files stored within a server in the customer's computer system in order to implement changes to the security controls. The changes to the security controls can be made while the existing software is operating. The changes to the security controls can be implemented into the existing software in no more than one day. Specifically, the changes to the security controls are in force the next time each user accesses the software from any workstation in the customer's computer system.

In general, the software security systems 100, 400 and 500 can process security controls at the local workstations or client computers, rather than at a central server. As a result, security controls can be assigned to as many widgets 26 as desired by the customer. The software security systems 100, 400 and 500 can build a GUI rapidly by performing about 100 to 1,000 security checks per second. For example, if the security administrator assigns security controls to 100 buttons or controls on the GUI, the software security systems 100, 400 and 500 can build the GUI according to the security permissions for each particular user in less than one second.

In some embodiments, the application performs security checks for each security-controlled widget 26 included in each display each time the displays are created. The application can also perform security checks for each security-controlled widget 26 affected by dynamic data changes each time the data changes, regardless of the current security requirements. When the security requirements change, the application can continue to check each security-controlled widget 26 each time the user attempts to access each widget 26, without the application requiring any modification. In this embodiment, all the security requirement changes occur outside of the application being controlled, and apply automatically to any workstation running the application on the network.

The software security systems 100, 400 and 500 can be used in any suitable setting, including private corporate settings or publicly-available commercial settings, such as retail sales via the Internet.

Various features and advantages of the invention are set forth in the following claims.

1. A method of implementing a software security system, the method comprising the acts of:
requesting permission to display a security-controlled file when a user attempts to access the security-controlled file;
determining a type of data in the security-controlled file from at least two types of data, the at least two types of data changing dynamically;
determining whether the user has access to the type of data; and
providing access to the security-controlled file if the user has permission to access the type of data.

2. The method of claim 1, and further comprising the act of installing the software security system on a customer computer system with default security settings.

3. The method of claim 1, and further comprising the act of allowing a security administrator to define security controls for the security-controlled file.

4. The method of claim 1, and further comprising the act of defining a denied appearance for the security-controlled file.

5. The method of claim 4, and further comprising the act of defining a denied appearance of one of hidden and disabled.

6. The method of claim 4, and further comprising the act of displaying the security-controlled file according to the denied appearance if the user does not have permission to access the type of data.

7. The method of claim 1, and further comprising the act of defining a security permission for the security-controlled file.

8. The method of claim 7, and further comprising the act of assigning the security permission to a security key for the security-controlled file.

9. The method of claim 7, and further comprising the act of identifying the security permission of a plurality of users by defining a user profile.

10. The method of claim 9, and further comprising the act of defining a plurality of relationships between the security-controlled file, the security permission, and the user profile.

11. The method of claim 10, and further comprising the act of generating a security table including the user profile, the plurality of relationships, and the security permission.

12. The method of claim 1, and further comprising the act of storing a security configuration file in a security repository module at a remote server.

13. The method of claim 12, and further comprising the act of generating from the security configuration file a security table.

14. The method of claim 13, and further comprising the act of downloading the security table from the security repository module to an access security module at a client computer when the user logs on to the client computer.

15. The method of claim 14, and further comprising the act of removing the security table from the access security module when the user logs off the client computer.

16. The method of claim 14, and further comprising the act of generating an internal security table at the client computer.

17. The method of claim 12, and further comprising the act of changing the security configuration file in the security repository module in order to change the user's access to the security-controlled file.

18. The method of claim 1, wherein the security-controlled file is an electronic-funds-transfer transaction file, and further comprising the act of determining a type of electronic-funds-transfer transaction from at least two types of electronic-funds-transfer transactions and determining whether the user has access to the type of electronic-funds-transfer transaction.

19. The method of claim 1, wherein the security-controlled file is a web page.

20. A software security system at least partially stored on a server and at least partially stored on a client computer, the software security system comprising:
a security repository module stored on the server, the security repository module storing a configuration file;
an access security module stored on the client computer for requesting permission from the security repository module for a user to access on the client computer a security-controlled file; and
a dynamic security module stored on the client computer for determining a type of data in the security-controlled file from at least two types of data, the at least two types of data changing dynamically, and for determining whether the user has access to the type of data based on the configuration file.

21. The software security system of claim 20, wherein the access security module and the dynamic security module are stored on the client computer with default security settings.

22. The software security system of claim 20, wherein the configuration file in the security repository module is created by a security administrator.

23. The software security system of claim 20, wherein the security repository module generates a security table from the configuration file.

24. The software security system of claim 23, wherein the security table includes a denied appearance for the security-controlled file.

25. The software security system of claim 24, wherein the denied appearance is one of hidden and disabled.

26. The software security system of claim 24, wherein the access security module displays the security-controlled file according to the denied appearance if the user does not have permission to access the type of data.

27. The software security system of claim 20, wherein the configuration file includes a security permission assigned by a security administrator to a security key for the security-controlled file.

28. The software security system of claim 27, wherein the configuration file includes a user profile defining the security permission for the security-controlled file for a plurality of users.

29. The software security system of claim 27, wherein the configuration file includes a plurality of relationships between the security-controlled file, the security permission, and the user profile as defined by the security administrator.

30. The software security system of claim 29, wherein the security repository module generates a security table including the user profile, the plurality of relationships, and the security permission.

31. The software security system of claim 29, wherein the access security module downloads the security table from the security repository module when the user logs on to the client computer.

32. The software security system of claim 31, wherein the software security system removes the security table from the access security module when the user logs off the client computer.

33. The software security system of claim 31, wherein the access security module generates an internal security table at the client computer.

34. The software security system of claim 20, wherein the security-controlled file is an electronic-funds-transfer transaction file and the dynamic security module determines a type of electronic-funds-transfer transaction from at least two types of electronic-funds-transfer transactions and determines whether the user has access to the type of electronic-funds-transfer transaction.

35. The software security system of claim 20, wherein the security-controlled file is a web page.

36. A method of implementing a software security system, the method comprising the acts of:
assigning a security permission for a user to a security key;
assigning the security key to a security-controlled application feature;
requesting access to the security-controlled application feature before allowing the user to access the security-controlled application feature;
determining a type of data associated with the security-controlled application feature from at least two types of data, the at least two types of data changing dynamically;
determining whether the user has access to the type of data; and
displaying the security-controlled application feature if the security permission assigned to the security key gives the user access to the type of data.

37. The method of claim 36, and further comprising the act of identifying the security permission of a plurality of users by defining a user profile.

38. The method of claim 37, and further comprising the act of defining a plurality of relationships between the security-controlled application feature, the security permission, and the user profile.

39. The method of claim 38, and further comprising the act of generating a security table including the user profile, the plurality of relationships, and the security permission.

40. The method of claim 36, and further comprising the act of storing a security configuration file in a security repository module at a remote server.

41. The method of claim 40, and further comprising the act of generating from the security configuration file a security table.

42. The method of claim 41, and further comprising the act of downloading the security table from the security repository module to an access security module at a client computer when the user logs on to the client computer.

43. The method of claim 42, and further comprising the act of removing the security table from the access security module when the user logs off the client computer.

44. The method of claim 42, and further comprising the act of generating an internal security table at the client computer.

45. The method of claim 40, and further comprising the act of changing the security configuration file in the security repository module in order to change the user's access to the security-controlled application feature.

46. The method of claim 36, wherein the security-controlled application feature is one of a control for a graphical user interface, a processing feature, an abstract process, and a control in a web page.

47. A software security system at least partially stored on a server and at least partially stored on a client computer, the software security system comprising:
a security repository module stored on the server, the security repository module storing a security permission for a user, the security permission being assigned to a security key, and the security key being assigned to a security-controlled application feature;
a security module stored on the client computer for requesting access from the security repository module for the user to access on the client computer the security-controlled application feature; and
a dynamic security module stored on the client computer for determining a type of data associated with the security-controlled application feature from at least two types of data, the at least two types of data changing dynamically, and for determining whether the user has access to the type of data based on the security permission for the user assigned to the security key for the security-controlled application feature.

48. The software security system of claim 47, wherein the access security module and the dynamic security module are stored on the client computer using default security settings.

49. The software security system of claim 47, wherein a configuration file is created by a security administrator and stored in the security repository module.

50. The software security system of claim 49, wherein the security repository module generates a security table from the configuration file.

51. The software security system of claim 50, wherein the security table includes a denied appearance for the security-controlled application feature.

52. The software security system of claim 51, wherein the denied appearance is one of hidden and disabled.

53. The software security system of claim 51, wherein the access security module displays the security-controlled file according to the denied appearance if the user does not have permission to access the type of data.

54. The software security system of claim 47, wherein the security permission is assigned by a security administrator to the security key for the security-controlled application feature.

55. The software security system of claim 49, wherein the configuration file includes a user profile defining the security permission for the security-controlled application feature for a plurality of users.

56. The software security system of claim 55, wherein the configuration file includes a plurality of relationships between the security-controlled application feature, the security permission, and the user profile as defined by the security administrator.

57. The software security system of claim 56, wherein the security repository module generates a security table including the user profile, the plurality of relationships, and the security permission.

58. The software security system of claim 50, wherein the access security module downloads the security table from the security repository module when the user logs on to the client computer.

59. The software security system of claim 58, wherein the software security system removes the security table from the access security module when the user logs off the client computer.

60. The software security system of claim 58, wherein the access security module generates an internal security table at the client computer.

61. The software security system of claim 47, wherein the security-controlled application feature is one of a control for a graphical user interface, a processing feature, an abstract process, and a control in a web page.

62. A computer system comprising:
a network;
a server connected to the network, the server including a security repository module; and
a web server connected to the network, the web server including
an operating system;
a web application running on the operating system; and
a foundation interacting with the web application, the foundation configured to interact with a web-browser-based client computer connected to the web server, the foundation including a security module for controlling a user's access to a security-controlled web page.

63. The computer system of claim 62, wherein the foundation is embedded in the web application.

64. The computer system of claim 62, wherein the security module includes an access security module for requesting permission from the security repository module for a user to access on the client computer the security-controlled web page.

65. The computer system of claim 64, wherein the security module includes a dynamic security module for determining a type of data in the security-controlled web page from at least two types of data, the at least two types of data changing dynamically.

66. The software security system of claim 65, wherein the access security module and the dynamic security module are stored on the client computer with default security settings.

67. The software security system of claim 62, wherein a configuration file is created by a security administrator and stored in the security repository module.

68. The software security system of claim 67, wherein the security repository module generates a security table from the configuration file.

69. The software security system of claim 68, wherein the security table includes a denied appearance for the security-controlled web page.

70. The software security system of claim 69, wherein the denied appearance is one of hidden and disabled.

71. The software security system of claim 69, wherein the access security module displays the security-controlled web page according to the denied appearance if the user does not have permission to access the type of data.

72. The software security system of claim 67, wherein the configuration file includes a security permission assigned by a security administrator to the security key for the security-controlled web page.

73. The software security system of claim 72, wherein the configuration file includes a user profile defining the security permission for the security-controlled application feature for a plurality of users.

74. The software security system of claim 73, wherein the configuration file includes a plurality of relationships between the security-controlled web page, the security permission, and the user profile as defined by the security administrator.

75. The software security system of claim 74, wherein the security repository module generates a security table including the user profile, the plurality of relationships, and the security permission.

76. The software security system of claim 75, wherein the access security module downloads the security table from the security repository module when the user logs on to the web-browser-based client computer.

77. The software security system of claim 76, wherein the software security system removes the security table from the access security module when the user logs off the web-browser-based client computer.

78. The software security system of claim 76, wherein the access security module generates an internal security table at the web-browser-based client computer.

79. The software security system of claim 62, wherein the security-controlled web page includes a plurality of electronic-finds-transfer transactions, and the dynamic security module determines a type of electronic-funds-transfer transaction from at least two types of electronic-funds-transfer transactions and determines whether the user has access to the type of electronic-funds-transfer transaction.

80. A software security system stored on a server and a client computer, the software security system comprising:
a security repository module stored on the server, the security repository module storing a configuration file and generating a security table based on the configuration file;
an access security module stored on the client computer for requesting permission from the security repository module for a user to access on the client computer a security-controlled file, the access security module downloading the security table from the security repository module when the user logs on to the client computer and removing the security table from the client computer when the user logs off the client computer; and
a dynamic security module stored on the client computer for determining a type of data in the security-controlled file from at least two types of data and for determining whether the user has access to the type of data based on the security table.
